(19) United States
(12) Patent Application Publication
(10) Pub. No.: US 2007/0176464 A1
(43) Pub. Date: Aug. 2, 2007

(54) Powered system for operating RV windows

(76) Inventor: Glenn D. Haley, Fort Myers Beach, FL (US)

Correspondence Address: Law Office of Brett N. Dorny, Suite 12A, 386 West Main Street, Northborough, MA, 01532, US

(21) Appl. No.: 11/513,909

(22) Filed: Aug. 31, 2006

Related U.S. Application Data
(60) Provisional application No. 60/713,524, filed on Aug. 31, 2005.

(51) Int. Cl. B60J 1/00

(52) U.S. Cl. 296/146.16

(57) ABSTRACT

The present invention provides a system for powered control of a window in a recreational vehicle. A bi-directional motor is positioned near the window to be controlled. The motor is coupled to the control for the window. The motor may be coupled through a belt and pulley system to the existing control knob or its shaft. The motor is controlled with a switch or a remote control.

### CROSS-REFERENCE TO RELATED APPLICATIONS

This application claims priority to U.S. Provisional Application Ser. No. 60/713,524, filed Aug. 31, 2005.

### BACKGROUND OF THE INVENTION

1. Field of the Invention

The present invention relates to systems for operating windows. More particularly, it relates to a powered system for operating windows in a recreational vehicle.

2. Discussion of Related Art

Over the years, recreational vehicles, including trailers, fifth wheels, and motor homes, have changed and improved significantly. Many of these advances have simplified operation of the vehicles. Changes have also improved the luxury of the vehicles.

Despite numerous advances in design and operation, little has changed with the operation of windows in recreational vehicles. FIG. 1 illustrates a conventional window 1 for an recreational vehicle. The window 1 typically is of the casement type having a frame 10 and a window 20. The casement 20 includes a glass pane 21 and a casement 22. The window is operated by manually turning a knob 30. The knob 30 typically is located in the frame 10 of the window 1. The knob 30 turns a control (not shown) within the frame 10 to rotate the window 20 away from the frame 10. The knob 30 is turned in one direction to open the window and in the other direction to close the window.

The manual operation of windows presents problems for recreational vehicle users. Often, furniture is placed along the walls of the recreational vehicle. The furniture is positioned in front of the windows. This makes it difficult to reach the knob. Additionally, the knob can be hard to turn. Older people, who often own and travel in recreational vehicles, can have difficultly turning the knob.

### SUMMARY OF THE INVENTION

The present invention provides a powered system for operating a window in a recreational vehicle. The system includes a bi-directional motor. According to one aspect of the invention, the motor is attached to the wall of the recreational vehicle near the frame of the window. A shaft of the motor is coupled to the shaft of the knob controlling the window. According to one aspect of the invention, the coupling includes a belt connecting pulleys on the shafts of the motor and knob. According to another aspect of the invention, the coupling includes a chain connected to gears on the shaft of the knob and motor.

According to another aspect of the invention, the motor is installed within the wall of the recreational vehicle. According to another aspect of the invention, the motor is installed within the frame of the window. According to one aspect of the invention, the motor is operated with a three position toggle switch. According to another aspect of the invention the motor is controlled with a wireless remote.

### BRIEF DESCRIPTION OF THE DRAWINGS

FIG. 1 is a front view of a conventional window in a recreational vehicle.

FIG. 2 is a front view of a system according to an embodiment of the present invention.

FIG. 3 is a top view of a system according to a second embodiment of the present invention.

FIG. 4 is a front view of a system according to a third embodiment of the present invention.

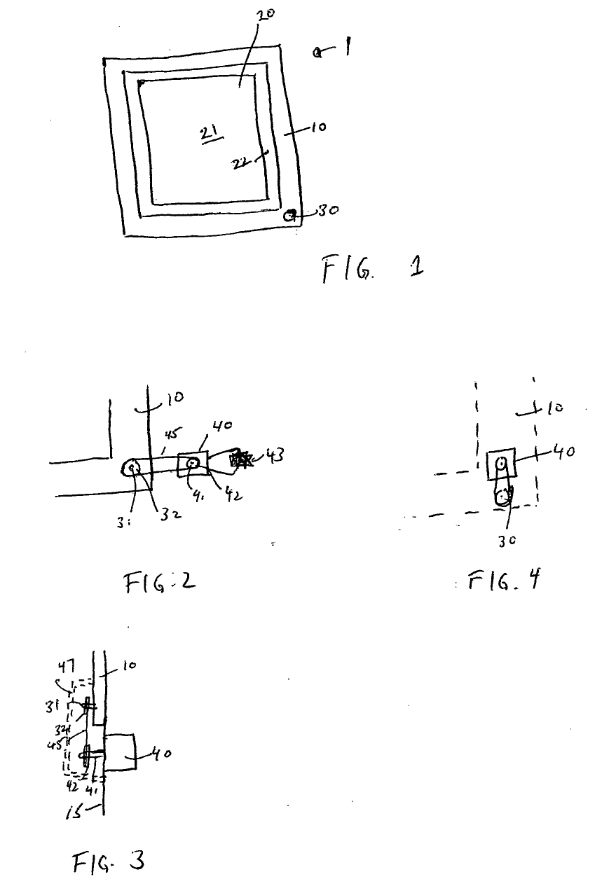

### DETAILED DESCRIPTION

The present invention, illustrated in FIG. 2, provides a powered system for operating a window in a recreational vehicle. The system includes a bi-directional motor 40 positioned near the frame 10 of a window. The motor 40 may be attached to the surface of the wall 15 of the recreational vehicle. Alternatively, as illustrated in FIG. 3, the motor can be installed within the wall 15. The motor 40 has a shaft 41 extending there from. A pulley 42 is connected to the shaft 41. According to an embodiment of the invention, a belt 45 connects the pulley 42 to the existing knob 30 for the window. According to a preferred embodiment, the knob 30 is removed from its shaft 31. A second pulley 32 is connected to the shaft 31 and attached to the belt 45. As the motor 40 turns, the knob 30 (or its shaft 31) is turned to operate the window. According to another embodiment of the invention, gears are connected to the shafts 31, 41 rather than pulleys. A chain is used in place of the belt 45. Using gears and a chain provides a tighter coupling between the motor and the window control system.

The motor is bi-directional. It turns in one direction to open the window and in the other direction to close the window. According to an embodiment of the invention, the motor 40 is operated with a three position toggle switch 43. When the switch 43 is in a center position, the motor 40 remains off. In a second position, the motor 40 is turned in the first direction. In a third position, the motor 40 is turned in an opposite direction. The switch can be positioned near or away from the motor. According to another embodiment of the invention, a remote control (not shown) is used instead of the switch 43. The remote control may operate with RF or infrared. According to another embodiment of the invention, as illustrated in FIG. 3, a cover 47 can be positioned around the system to hide it from view.

FIG. 4 illustrates another embodiment of the invention. The embodiments shown in FIGS. 2 and 3 can be installed in existing recreational vehicles. However, the parts are visible or hidden with a cover extending from the window. They lack the esthetics desired for recreational vehicles. In the embodiment illustrated in FIG. 4, the motor 40 is positioned behind the frame 10 of the window. The motor 40 can be connected to the knob shaft 31 in the same manner as for the other embodiments. Alternatively, the motor 40 can be connected directly to the control for the window. Due to the placement of the motor 40 behind the frame 10, no knob 30 is required. The entire structure can be hidden from view.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A system for operating a window in a recreational vehicle, wherein the window is operated with a knob with a shaft extending from the frame of the window, the system comprising:
a bi-directional motor having a shaft;
a first pulley attached to the shaft of the motor; and
a belt coupling the first pulley to the shaft of the knob.

2. The system according to claim 1 wherein the belt is connected to the knob.

3. The system according to claim 1, further comprising a second pulley attached to the shaft of the knob; and wherein the belt connects the first pulley to the second pulley.

4. The system according to claim 3, wherein the first pulley includes a gear, the second pulley includes a gear, and the belt includes a chain.

5. The system according to claim 1, further comprising a cover positioned over the motor, pulley and belt.

6. The system according to claim 1, further comprising a three position switch for operating the motor.

7. The system according to claim 1, further comprising a remote control for operating the motor.

8. The system according to claim 1, wherein the motor is attached to the wall of the recreational vehicle.

9. The system according to claim 1, wherein the motor is positioned within the wall of the recreational vehicle.

10. The system according to claim 1, wherein the motor is positioned behind the frame of the window.
